(19) United States
(12) Patent Application Publication
(10) Pub. No.: US 2010/0325665 A1
(43) Pub. Date: Dec. 23, 2010

(54) Automatic Web Searches Based on EPG

(75) Inventor: Dale Llewelyn Mountain, Keighley (GB)

Correspondence Address: DORSEY & WHITNEY LLP;on behalf of EchoStar Technologies, L.L.C., 370 Seventeenth St., Suite 4700, Denver, CO, 80202-5647, US

(73) Assignee: Eldon Technology Limited, Keighley (GB)

(21) Appl. No.: 12/486,617

(22) Filed: Jun. 17, 2009

(51) Int. Cl. H04N 5/445

(52) U.S. Cl. 725/44

(57) ABSTRACT

An enhanced graphical user interface to a user, such as an electronic programming guide, including certain selectable attributes. When a particular attribute is selected, a network transaction may be initiated to a website or other network node. Information or other content received from the network node may be displayed as output. The output may include indications of upcoming or future programs that are related to a particular selected attribute. The output may also include a select link that operates to automatically set a timer to record one or more upcoming programs that are related to the selected attribute.

### TECHNICAL FIELD

Implementations discussed herein are generally directed to automatically conducting web searches based on user selections of certain attributes in a graphical user interface.

### BACKGROUND

Television programming services may be provided through program service transmissions, whether satellite, cable, or other mechanisms. A program service transmission may include digital information regarding certain programs or movies which are scheduled to occur, for example, scheduling information, program or movie titles and/or actors which star in the titles. This information may be displayed in a graphical user interface, such as an electronic programming guide, which displays the scheduling and other information to the user. Due to bandwidth constraints associated with the television program service transmission, a limited amount of information regarding the scheduled programs may be included for display and viewing by a user. This may leave a user wanting further information regarding one or more of the programs or movies which are scheduled to be shown in connection with the television service. For example, a user may want to know who directed a particular movie or what other movies feature a particular actor.

### SUMMARY

Implementations discussed herein are directed to providing an enhanced graphical user interface to a user. A graphical user interface, such as an electronic programming guide, may be enhanced by indicating certain attributes as being selectable. When a particular attribute is selected, a network transaction may be initiated to a website or other network node. Information or other content received from the network node may be displayed as output. The output may include indications of upcoming or future programs that are related to a particular selected attribute. Moreover, the output may also include a select link that operates to automatically set a timer to record one or more upcoming programs that are related to the selected attribute.

Embodiments discussed herein are directed to a method in a receiver having at least a processor, a signal receiver and an output, the method being for accessing information in an electronic programming guide, the electronic programming guide being transmitted to the receiver from a program service, the method comprising: receiving, through a signal receiver, an input signal indicating that a selected attribute has been chosen from the electronic programming guide, the electronic programming guide being displayed on a display; in response to receiving the input signal, selecting, by the processor, a tag associated with the selected attribute; in response to selecting the tag, initiating a network transaction across a network to a network node, the network transaction including sending data associated with the tag through the output; in response to initiating the network transaction, receiving a reply from the network node over the network; and in response to receiving the reply, outputting information contained in the reply as part of a data stream for display, the information being associated with the selected attribute.

Other embodiments discussed herein are directed to a method in a receiver having at least a signal receiver, a processor and network connection, the method being for accessing information in an electronic programming guide, the electronic programming guide being transmitted to the receiver from a program service, the method comprising: receiving, through a signal receiver, an input indicating that a selected attribute has been chosen from the electronic programming guide; in response to receiving the input, receiving, through the network connection, a list of titles associated with the selected attribute from a network node; in response to receiving the list of titles, searching, by the processor, electronic programming guide data to determine a match between a future program and a title in the list of titles; and outputting an indication of the future program as part of a data stream for display.

Still other embodiments discussed herein are directed to a television receiving device, comprising: a display comprising a user interface, the user interface configured to receive user input and including at least one selectable attribute; a memory configured to store an electronic program guide data; a network connection configured to communicate across a network with at least one network node; and a processor in communication with the memory, the user interface and the network connection, the processor configured to display information on the display, the information being associated with the at least one selectable attribute; wherein the information displayed on the display is received from the network node in response to a network transaction initiated by the processor; wherein the network transaction is initiated by the processor in response to an input signal indicating a user selection of the at least one selectable attribute.

### BRIEF DESCRIPTION OF THE DRAWINGS

FIG. 1 is schematic diagram showing components and features of implementations discussed herein;

FIG. 2 is a screen shot of the display shown in FIG. 1;

FIG. 3 is an illustration of a tagged string in accordance with implementations discussed herein;

FIG. 4 is an illustration of a rule table in accordance with implementations discussed herein;

FIG. 5 is a flow chart showing a method in accordance implementations discussed herein;

FIG. 6 is another screen shot of the display shown in FIG. 1;

FIG. 7 is still another screen shot of the display shown in FIG. 1; and

FIG. 8 is a flow chart showing another method in accordance implementations discussed herein.

### DETAILED DESCRIPTION

Embodiments discussed herein are directed to an apparatus and method for providing an enhanced graphical user interface. A graphical user interface may be displayed at a receiver and show information regarding movies, programs or other features provided from a service provider. An enhanced graphical user interface may include a display of information or other content received in connection a with network transaction that is automatically initiated in response to user selections of a certain attribute of the graphical user interface.

As used herein, a “receiver” may be any device capable of receiving video content included in a broadcast or other program service transmission from a service provider. For example, a receiver may include a set-top box, a cable box, general purpose computer, and so on. As used herein, a “service provider” may include any entity that provides a program service transmission to a receiver such as, without limitation, a satellite television distributor, a direct television provider or a cable television company. It should be understood that the term “program service transmission” generally embraces not only satellite or terrestrial broadcasts and/or narrowcasts but also transmission of information across any wired or wireless transmission medium. Accordingly, a “program service transmission” encompasses transmission of information across a cable network (for example from a cable headend to cable receiver), an Internet or other computer-accessible medium (including a local area network, wide-area network, and so on), including Internet protocol television transmissions, a wireless network such as a radio frequency or infrared network, and so on.

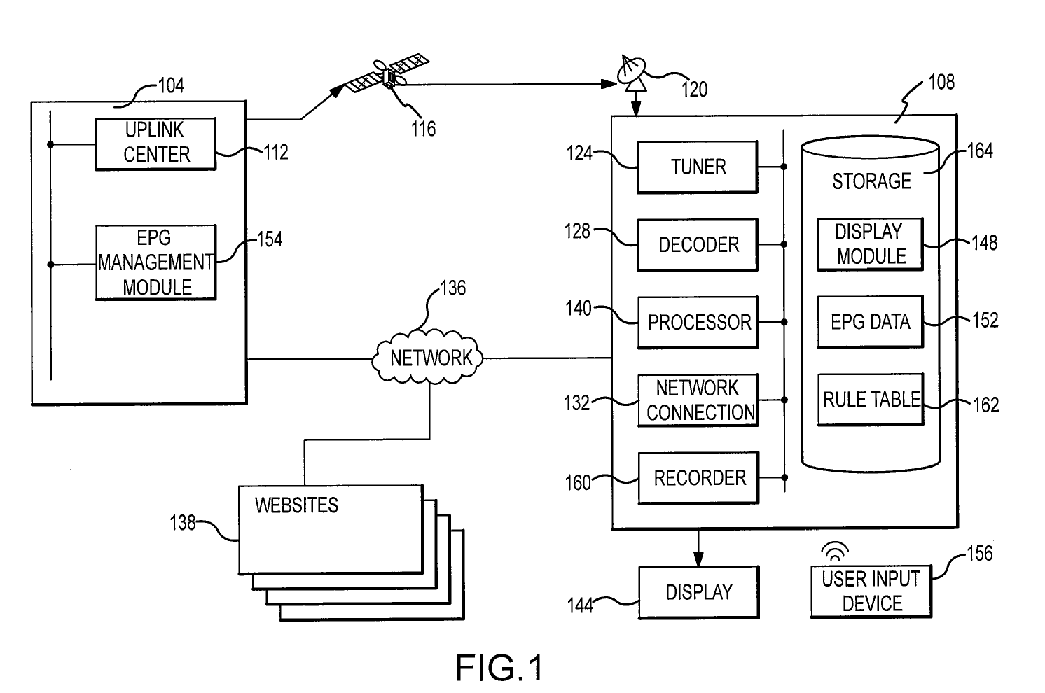

FIG. 1 is a schematic illustration of a general operating environment showing components and features of embodiments discussed herein. FIG. 1 includes a service provider 104 that transmits or otherwise provides a program service transmission to a receiver 108. The receiver 108 can include a set-top box (STB), Digital Video Recorder (DVR), a cable receiver, a general purpose computer and so on. A receiver 108 may also include a cable modem or raster that receives streaming video.

The receiver 108 may be associated with or located near an individual, business or other entity, user or subscriber that receives a program service transmission from the service provider 104. The program service transmission may be received through a subscription to the service. Generally the terms “user” and/or “subscriber” refer to an individual or company who receives a program service transmission. This may include those who have purchased a subscription to the program service transmission. Additionally, the terms “user” and/or “subscriber” may refer to individuals who have been given access to the program service transmission through promotional offers and/or other non-fee-based agreements.

In connection with embodiments that operate in the context of a satellite television service, the service provider 104 may provide a program service transmission through an uplink center 112. The uplink center 112 may include a transmitter or other equipment operable to transmit a modulated signal having data representing audio and/or visual content. The modulated signal may be received at a satellite 116, which in turn retransmits the modulated signal to be received at one or more terrestrial locations. The retransmitted signal may be received from the satellite 116 at one or more satellite dishes 120, which are typically associated with one or more receivers 108. A receiver 108 may include a tuner 124 operable to receive the program service transmission signal through the satellite dish 120 and a decoder 128 to decode the received signal. The decoder 128 may be programmed to decrypt or otherwise decode some or all of the received signal in accordance with purchases and selections made by a user.

Again, it should be noted that embodiments may operate with different product transmission services. Accordingly, although a satellite system is provided as an example of a program service transmission system, it should be understood that other networks or broadcasts for transmitting data may be used by alternative embodiments. For example, embodiments may be implemented in connection with a cable service. In this case, the service provider 104 and the receiver 108 may communicate over a communication path that includes various combinations of local and wide area networks and/or the Internet. In such embodiments, the receiver 108 may be configured to access a web site, a file transfer protocol (FTP) site, a file sharing system or site, and so on.

A particular receiver 108 may include a network interface 132. The network interface 132 may be operable to communicate or send information across a network 136. In accordance with certain embodiments discussed herein, the network interface 132 may take the form of a modem network interface card, cable plug or jack, and so on. Using the interface, the receiver may communicate over a network 136 such as the public switched telephone network (PSTN). However, it should be appreciated that the network 136 may be any type of network capable of data communication, such as, for example, a local or wide area network or the Internet. The receiver 108 may communicate through the network connection 132 using any suitable communication protocol such as TCP/IP. Through the network interface 132, a user may communicate with the service provider 104 to change his or her account status including taking such actions as adding or canceling channels and/or ordering pay-per-view content. In accordance with implementations discussed herein, the receiver 108 may communicate with one or more websites 138 through the network connection 132. In so doing, the receiver 108 may reference and receive information or other content that may be outputted on a display to provide enhanced or expanded graphical user interface.

The receiver 108 may additionally include a processor 140 operable to run executable code in connection with various functions associated with the receiver 108. For example, the processor 140 may display graphics, images, animations or other content on a display 144, such as a television (TV) or monitor. In the case of receiving commands or other information relating to changes to the account status, the processor 140 may be further operable to initiate or facilitate transmission of one or more messages to the service provider 104. The processor 140 may be further operable to recall and display stored content, such as a purchased or recorded videos or programs.

Among other functions, the processor 140 may also receive, store and/or display an Electronic Program Guide (EPG), which may provide a schedule of program content and/or other features. As used herein, the terms “electronic programming guide” or “EPG” are intended to encompass an interface that includes a schedule of programming content provided to a user as part of a program service transmission system. The EPG may comprise a database or may otherwise access a database containing information including, for example, names or titles of viewing events (programs), corresponding channel numbers and names, brief descriptions of the programs, start and finish times, and rating and content information related to the events. The processor 140 may execute a display module 148 or program, which may access stored EPG data 152 and provide a formatted graphic output on the display 144. The EPG data 152 may complied at the service provider 104 through the operation of an EPG management module 154 and transmitted to the receiver 108. In accordance with implementations discussed herein, the EPG management module 154 may provide certain EPG strings or other data with tags that may be used to facilitate web or other network searches.

The processor 140 may perform such tasks as executing commands received from a user. User commands may be sent to the receiver 108 through a user input device 156 such as remote or other wireless device. As used herein, a “user input device” may include any device operable to receive input from a user and to convey the input to the receiver 108. In one embodiment, the user input device 156 may be a hand-held device having a number of buttons or keys that when actuated by a user cause the user input device 156 covey information to the receiver 108 using a suitable communication means, such as an infrared signal. The user input device 156 may include a pointing device or functionality that allows the user to control the position of a cursor that is displayed on the display 144. For example, the user input device 156 may include a track ball or glide plane that may be manipulated to control cursor movements. The user input device 156 may include a motion sensor or accelerometer that allows a user to control displayed items or graphics, such as a cursor, through movements of his or her hand or arm that cause a displacement of the user input device 156. It should be appreciated that other input devices such as a computer mouse or touch screen may be used and other communication means, wired or wireless, may be used. Information sent to the receiver 108 may include, for example, a command to change the displayed channel, a command to pause and/or rewind a displayed program, a command to record a particular program, a command to purchase a pay-per-view item, a command to display an EPG and/or a command to navigate through the EPG. Commands sent to the receiver 108 may be entered through a dedicated display menu.

The receiver 108 may include or be associated with a recorder 160, such has a digital video recorder (DVR). The recorder 160 may be integrated into the receiver 108 or may be a stand alone device. The recorder 160 may be operated by a user who programs the device or receiver function to record a particular program at a specified time. When the program occurs, the recorder 160 will record and store the program, which can then be viewed later. In addition to this functionality, the recorder 160 may buffer a certain amount of content during a live transmission. Buffering a live transmission allows a user to pause and/or rewind the content of the transmission and to then display the content in a non-live or delayed manner.

The receiver 108 may include or be associated with a memory or other storage device 164, such as magnetic or optical storage. The storage device 164 may be operable to store data received from the decoded satellite signal. The storage device 164 may be volatile or non-volatile memory implemented using any suitable technique or technology such as, for example, random access memory (RAM), disk storage, flash memory, solid state and so on. The storage device 164 may be located within the receiver 108 or separately from the receiver 108. The storage device may removable in nature. The stored data set may include audio and/or visual content to be transmitted and displayed through the display 144. Generally, audio visual content may include still images, video images, animation and/or audio. Portable Network Graphics (PNG) or other appropriate formats, such as for example, Tagged Image File Format (TIFF), Joint Photographic Experts Group (JPEG), Motion Picture Experts Group (MPEG)-2, MPEG-4 may be used to display an image or video. As a result commands or setting from a user, videos or other program may be stored locally in storage 164. Stored program may include for example recorded broadcasts, pay-per-view items and/or buffered portions of a live video broadcast.

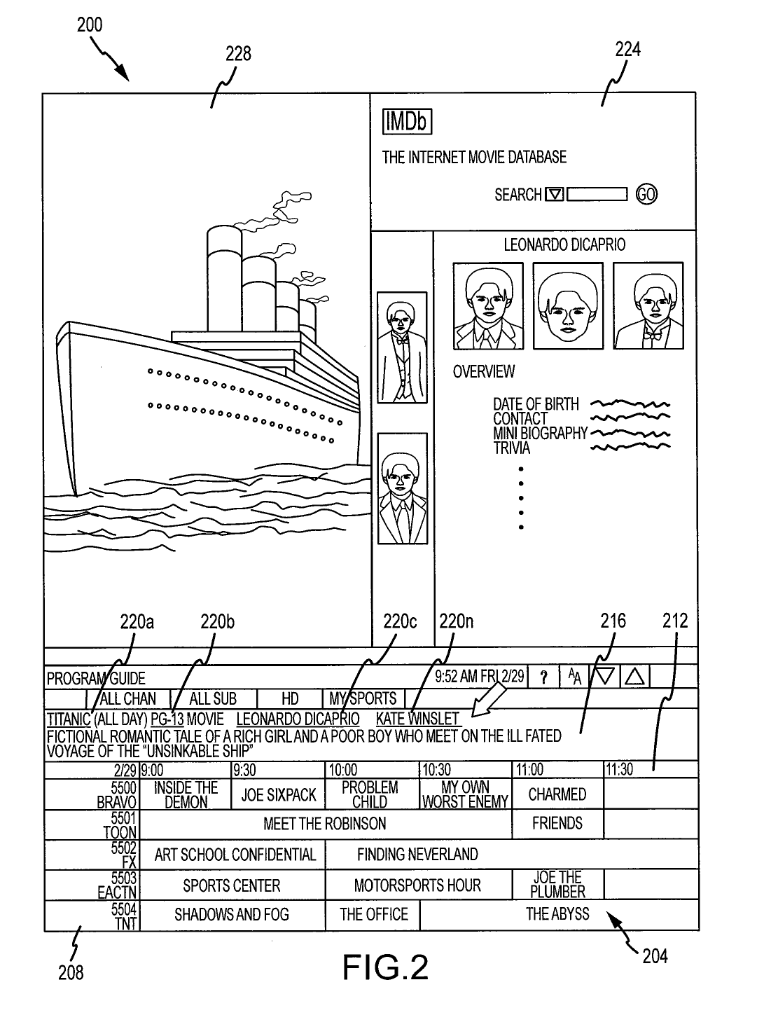

The storage device 164 may additionally store an application, file, module or other data that is useable by the processor 140. In one instance, the stored application may be executed by the processor 140 to display content on the display 144. As used herein, an application or module includes processor executable code that may be run to carry out one or more functions associated with the receiver 108. “Processor executable code” includes any computer-readable media or commands that may be ultimately interpreted by a processor, such as HTML or XML files that are rendered into user-viewable applications by an application executed by the processor. An example of a module stored on the storage device is the display module 148. The operation of the display module 148 will now be described with reference to FIGS. 2-8.

FIG. 2 shows a screen shot of the display 144. At least a portion of the screen 200 is dedicated to a graphical user interface that includes an EPG display 204. The EPG display 204 is laid out in the form of a grid or array of blocks having a number of rows and columns. The EPG display 204 includes a channel column 208 which provides information regarding channels that are available or potentially available from the service provider 104. The EPG display 204 additionally includes a time row 212 providing a series of time increments. The channel column 208 and the time row 212 reference a number of blocks per channel. A particular block lists a program, movie or feature that is scheduled to occur on the channel specified by the channel column 208 at the time specified by the time row 212. Additionally, the EPG display 204 may list on-demand or pay-per-view features that are not scheduled to occur at a particular time of day. In this regard, the EPG display 204 may include more and more pay-per-view or on-demand blocks 216.

Each block in the EPG display 204 may include information that indicates a scheduled program, movie, or other feature. The EPG display 204 may include a title of the program. In some implementations, an EPG display 204 block may include more detailed information regarding the scheduled program. For example, the on-demand block 216, shown in FIG. 2, includes a title of the scheduled program as well as information such as actors appearing in the movie, the movie's rating, and a brief description of the movie. As used herein, an “attribute” refers to an item that is associated with an EPG block or other display of information such as, for example, a title, actor, rating, and so on. Certain attributes may be selectable by a user. In particular, the user may manipulate the user input device 156 to select an attribute using an on-screen cursor or other pointing icon. Selectable attributes may be differentiated from non-selectable attributes by highlighting, underlining, backlighting, or otherwise emphasizing the selectable attribute.

The pay-per-view item 216, shown in FIG. 2, includes a number of selectable attributes 220a-n indicated therein by means of an underline. Specifically, the movie's title “Titanic” 220a is underlined and therefore indicated as being selectable. The movie's rating, namely “PG-13” 220b, is underlined and thereby indicated as being selectable. Additionally, the actors, “Leonardo DiCaprio” 220c and “Kate Winslet” 220n are underlined and thereby indicated as being selectable. When a selectable attribute is selected by a user, the display module 148 or other program running on the receiver 108 may initiate a web transaction through the network connection 132 across the network 136 to one or more websites 138. In connection with conducting a network transaction, the display module 148 may use tags that are associated with the attributes contained in the EPG data 152. Attribute contained in the EPG data 152 such as, for example, director, genre and certain keywords may be selectable.

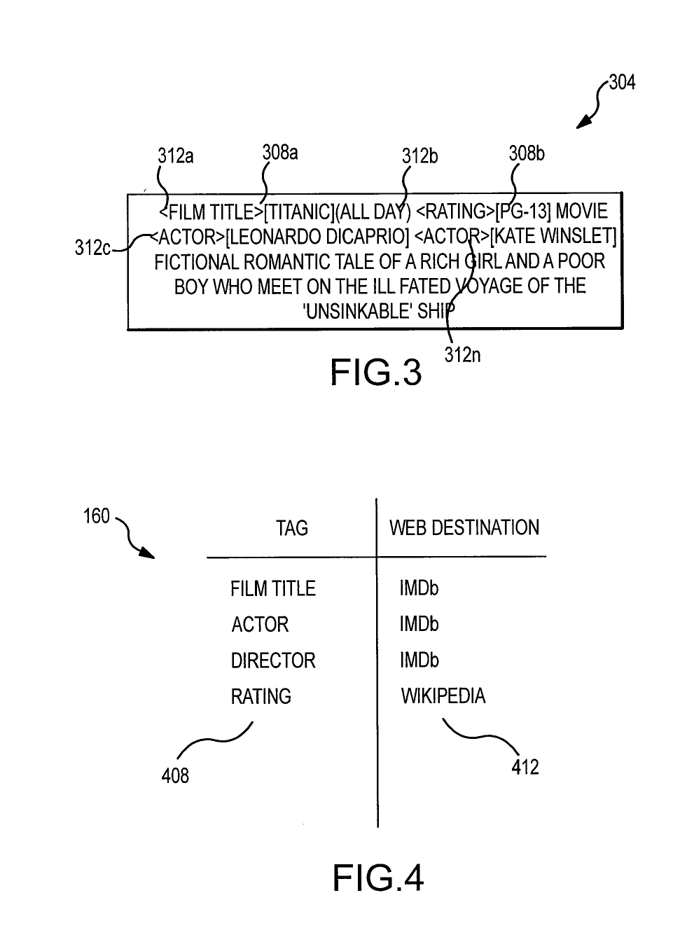

Selectable attributes may be specified by a tagged string that forms part of the EPG data 152. Turning now to FIG. 3, a tagged string is generally indicated with reference numeral 304. In connection with an EPG, a particular tagged string 304 may be associated with a program specified by information in a particular grid entry or block in the EPG display 204. In this regard, the tagged string 304 may be received along with other EPG data 152 from the service provider 104 through a communication path including, in one embodiment, the satellite dish 120. The tagged string 304 may include text that is displayed in a EPG display 204 entry as well as metadata or other non-displayed characters that indicate to the display module 148 which particular attributes or portions of the tagged string 304 are to be highlighted or otherwise indicated as being selectable. In one instance, such as that shown in FIG. 3, the tagged string 304 includes a number of bracketed attributes 308a-n. Brackets are used herein by way of example and not limitation. Accordingly, other offsets such as braces or parenthesis may be used. The brackets may indicate that the attribute enclosed by the bracket is to be underlined or highlighted, thereby indicating that the attribute or text within the brackets is selectable by a user. Text not appearing in brackets may be displayed by the display module 148 without any underlining or highlighting, indicating that this portion of the text is not selectable by a user. Comparing FIG. 3 and FIG. 2, it can be seen that the bracketed attributes “Titanic” 308a, “PG-13” 308b, “Leonard DiCaprio” 308c, and “Kate Winslet” 308n correspond to selectable attributes 220a-n in the EPG display 204 shown in FIG. 2.

FIG. 3 also shows a number of tags 312a-n. A tag 312a-n generally precedes a bracketed attribute 308a-n and is therefore associated with the bracketed attribute 308a-n. It should be appreciated that this association is by way of example and not limitation. Accordingly, other implementations may include a tag 312a-n that is associated with a bracketed attribute 308a-n by its placement following the bracketed attribute 308a-n. The tag 312a-n is associated with the bracketed attribute 308a-n and indicates an attribute type. For example, the tag 312a is associated with the bracketed attribute 308a. The tag 312a indicates that the bracketed attribute 308a, namely “Titanic,” is a film title. Similarly, the tag 312b is associated with the attribute 308b. The tag 312b indicates that the attribute 308b, namely “PG-13”, is a rating. Likewise, the tags 312c and 316n indicate that the attributes to which they are associated are actors. It should be appreciated that the tags 312a-n are used by the graphical interface module 148 to interpret and/or understand the text of the tagged string 304 and are not displayed.

When a user selects a particular EPG attribute 220a-n through the EPG display 204, a network transaction may be initiated by the embodiment to acquire more information regarding the selected attribute. In the network transaction, the display module 148 may pass the string, which is contained in the bracketed attribute 308a-n, to a website 138. Additionally, or in combination, the display module may format and pass a database query of a particular type that include data contained in the bracketed attribute 308a-n. The website 138 may be chosen based on the tag 312a-n that is associated with the bracketed attribute 308a-n. In particular, a particular website 138 may be designated as a recipient for network transactions of a certain type. For example, for inquiries for information regarding film titles, the Internet Movie Database (IMDB) may be used to acquire such information. Alternatively or in combination, inquires may be passed to other websites, proprietary sites or databases.

FIG. 4 shows a table 160 that may be maintained in data storage 164 or remotely from the receiver 108 that specifies a rule or relationship between a certain type of tag 312a-n and a particular web destination 138. The table 404 includes a tag column 408, having a number of entries that are associated with entries in a web destination column 412. As shown in the example given in FIG. 4, the tags “Film Title”, “Actor”, and “Director” are associated with the IMDB website. Additionally, the tag “Rating” is associated with the Wikipedia website. It should be appreciated that the rules or associations shown in FIG. 4 are by way of example and not limitation. It is contemplated that other combinations of websites or other website names or destinations may be used in other implementations. The rules contained in the table 404 may be specified by the service provider 104. These rules or associations may simply be defaults, which are changeable by a user through user input provided through the user input device 156. Alternatively, these associations may be specified by the service provider 104 and not changeable by the user.

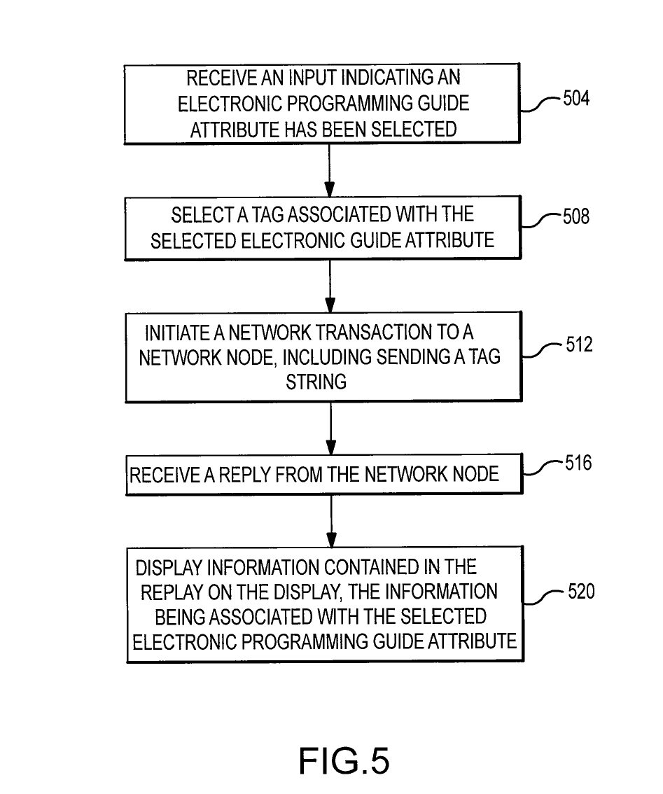

FIG. 5 includes a flowchart illustrating a method of receiving and displaying information in connection with user selections of attributes. Initially, at operation 504, the receiver 108 receives an indication that an EPG attribute 220a-n has been selected by a user. The input signal may be received in response to the user manipulating the user input device 156 to place a cursor over a highlighted attribute and subsequently pressing a selection button or other actuator to select the selectable attribute 220a-n. After operation 504, operation 508 may be executed.

At operation 508, the display module 148 may select a tag 312a-n that is associated the selected attribute 220a-n. This may be done with reference to a tagged string 304 that is associated with a particular EPG display 204 block. The EPG attribute 220a-n that was selected by the user will be associated in the string 304 with a particular tag 312a-n. For example, if a user selects the highlighted attribute “Titanic” 220a shown in FIG. 2, reference will be made to the string 304 which indicates that the bracketed attribute “Titanic” 308a is associated with the tag 312a. The tag 312a indicates that the selected EPG attribute 308a is a film title. After operation 508, operation 512 may be executed.

In operation 512, the display module 148 may initiate a network transaction to a particular network node. In one embodiment, the network node specified by the network transaction is a website 138. The particular website 138 that the network transaction is directed to may be specified by the tag 312a acquired in step 508. Moreover, the web destination may be chosen by a rule such as that shown in FIG. 4. Continuing with the example above, the tag “Film Title” 312a was acquired in step 508. Accordingly, by the rule defined in FIG. 4 the IMDB website will be the destination of the network transaction in operation 512. Following operation 512, operation 516 may follow.

In operation 516, a reply may be received from the network node. The reply received in operation 516 may include information that was acquired by passing the attribute 308a to the network node. Following operation 516, operation 520 may be executed and the display module 148 may display information received in operation 516 on the screen 200. The information displayed in operation 520 may be associated with the EPG attribute 220a selected by the user initially. In this way, the user is provided with access to a greater range of information regarding attributes 220a-n for other items in the EPG display 204.

Several formats or other arrangements for displaying information received through a network transaction are contemplated. In one embodiment, a webpage may be displayed on the screen 200. One implementation of this type of display is shown in FIG. 2. In particular, the webpage 224 is displayed in a window overlaying a portion of the screen 200. In one embodiment, the webpage 224 may cover only a part of the screen 200. Alternatively, the entire screen 200 may be dedicated to displaying the webpage 224. In some embodiments, the webpage 224 and/or the EPG display 204 may be overlain on a program, movie or other feature displayed by the channel to which the receiver 108 is tuned. The implementation shown in FIG. 2 includes a portion 228 of the screen 200 dedicated to displaying a program or movie. The webpage 224 shown in FIG. 2 may include other selectable attributes which may be navigated through by a user by manipulating a user input device 156. Alternatively, the user may simply view information that is available on the first webpage 224 provided through the network transaction and displayed on the screen 200. Such displays may include pictures, dates of birth, contact information, biography information, and so on.

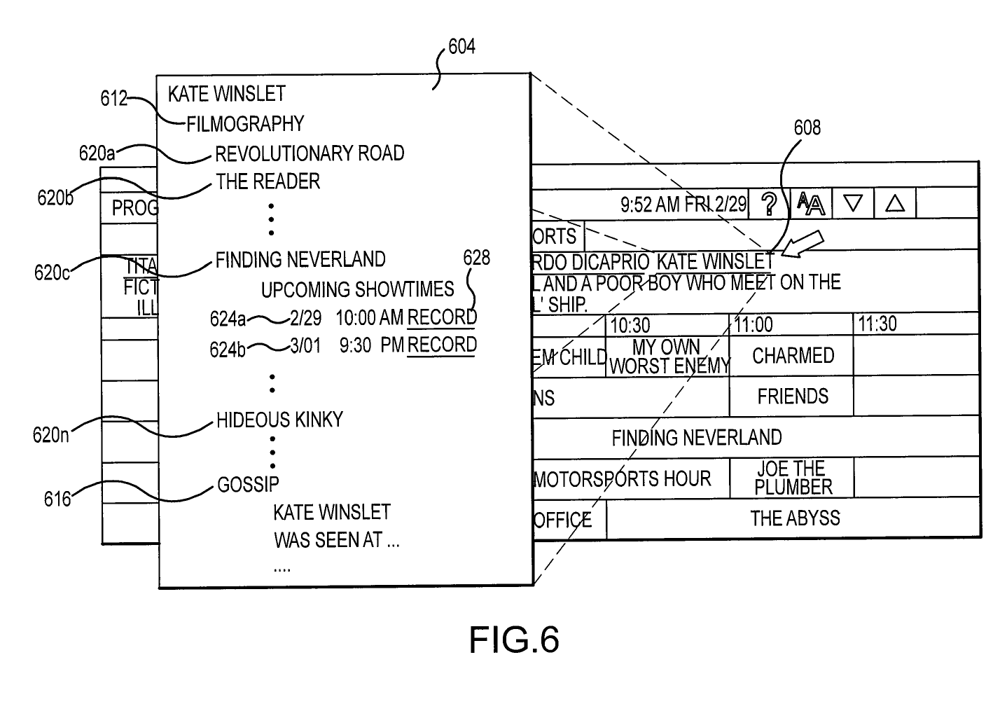

In other implementations, the information received from a network transaction submitted in response to a user selection of an attribute may be received, parsed, formatted and displayed in a particular format specified by the display module 148. The information so displayed may include raw data or information received from a website 138 and may not include other items associated with the website, such as the website's title, advertisements, pictures, and so on. One such particularly formatted display is shown in FIG. 6. FIG. 6 shows a display 604, such as a window or overlay that is displayed on the screen 200 in response to a user selection of an attribute. In particular, the window 604 includes information about the attribute “Kate Winslet” 608 displayed in a format specified by the display module 148. The content of the information is received from a website 138 external to the receiver 108. The information is received in response to a network transaction that occurs following the user selection of the highlighted attribute 608, shown in FIG. 600.

The information displayed in window 604 may be organized in terms of various categories. For example, FIG. 6 shows a filmography category 612 and a gossip category 616. A particular category may include a number of attributes listed therein. In one embodiment, a gossip category 616 may be included in the display 604. Here, headlines or summaries of recent online articles may be displayed which are related to the selected attribute (in this case, “Kate Winslet”). As shown in FIG. 6, the filmography category 612 may include attributes such as “Revolutionary Road” 620a, “The Reader” 620b, “Finding Neverland” 620c, and “Hideous Kinky” 620n. The attributes in the filmography category 612 thus may include a list of titles in which the actress “Kate Winslet” appears. The listed titles may be imported from a database or other source of information which is located external to the receiver. In one embodiment, a category, such as filmography 612, may be collapsed or expanded. In particular, the filmography category 612 may be selected, such as through a double click, to display or not display the list of associated attributes.

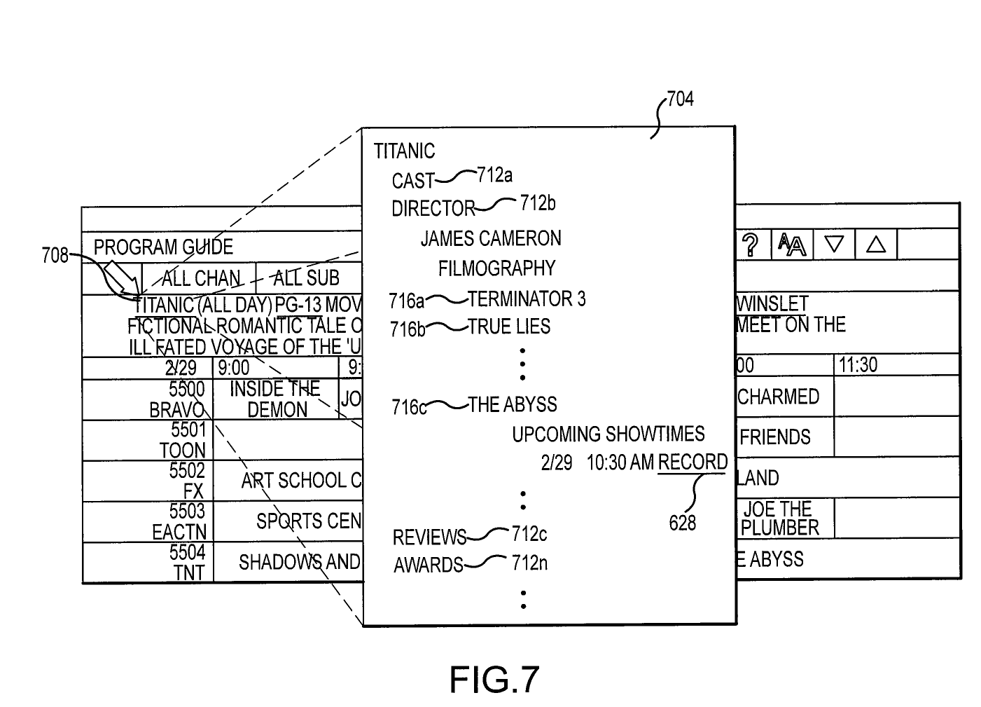

In accordance with implementations discussed herein, a certain attribute that is received through a web transaction may also be tagged and thereby selectable by user in a display to initiate a second or subsequent network transaction to acquire still more information. For instance, FIG. 7 shows a display 704 of information associated with the attribute 708 that may be selected by a user. In this case, the user has selected the attribute “Titanic” 708. Accordingly, the display 704 lists or otherwise displays a number of categories and associated attributes which are provided in connection with the attribute “Titanic” 708. The information contained therein may be acquired through a web transaction which is directed to a particular website 138 and which includes passing the string “Titanic” as specified by an associated tag which is contained in the tagged string associated with the appropriate EPG block. As shown in FIG. 7, the display 704 includes categories such as “Cast” 712a, “Director” 712b, “Reviews” 712c, “Awards” 712n. It should be appreciated that the list of categories or attributes shown in FIG. 7 is by way of example and not limitation. Other categories or attributes may be displayed such as “Release Date”, “Genre”, “Producers”, “Viewer Ratings”, “Language”, and so on. One or more categories or attributes may be tagged, indicating that the category or attribute is selectable. The category “Director” 712b may be expanded or otherwise selected to list the director of the associated attribute, namely James Cameron. As shown in FIG. 7, the attribute “James Cameron” 712b may include a filmography category listing a number of relevant titles. As shown in FIG. 7, the James Cameron filmography includes such titles as “Terminator 3” 716a, “True Lies” 716b, and “The Abyss” 716c. It should be appreciated that any number of subsequent web or network transactions may occur as a user selects various attributes that are displayed on the screen 200.

In some implementations, the information received from one or more network transactions may be compared with EPG data 152 to determine matches between such items as those contained in a filmography and those programs or movies that are scheduled to occur at some time in the future. When a match is found between a title in a filmography or other listing and a future program or movie, information may be displayed on the screen 200. For example, as shown in FIG. 6, the “Kate Winslet” filmography 612 includes the title “Finding Neverland” 620c. In this case, a comparison of the title “Finding Neverland” with EPG data 152 may result in a match. Specifically, it may be determined that the movie “Finding Neverland” is to be shown on the “FX” channel at 10 o'clock. Accordingly, the display 604 may include an indication that upcoming or future show times exist for the title “Finding Neverland”. Specifically, one entry 624a is shown in FIG. 6 indicating that an upcoming show time of “Finding Neverland” will occur on February 29 at 10 a.m. Other upcoming show times which are not immediately available or immediately viewable in the displayed EPG display 204 may also be shown on the display 604. In this regard, the display 604 includes a second showing 624b or upcoming feature of the title “Finding Neverland”, which is scheduled to occur on March 1 at 9:30 p.m. Selecting the future display time, may cause the relevant portion of the EPG display 204 to be shown on the screen 200. In addition to showing a listing of upcoming or future showings of a particular title at a particular time, the display 604 may additionally include a selectable link 628 which, when selected by user, may cause a DVR or other recorder 628 associated with the receiver 108 to record the program.

It should be appreciated that in some instances, the comparison of information which results in a display of upcoming or future programs is accomplished with information available in the EPG guide. For instance, two EPG guide blocks may specify or contain within themselves information about actors starring in movies so specified. In other instances, correlations may be made between scheduled programs based on information not available in the EPG guide. More specifically, correlations may be made based on information that is received from an external source such as a website through a network transaction. This situation is illustrated in FIG. 7. In FIG. 7, a correlation is made between the movie “Titanic” with a subsequently shown feature, namely “The Abyss”. This is done by first displaying a list of categories associated with the film title “Titanic”. Under the “Director” category which specifies the film's director “James Cameron”, a filmography, title is listed. Both the name of the director and the titles associated with the director are not acquired from the EPG data only. More specifically, this information is acquired from a network transaction which is initiated in response to user selection of the attribute “Titanic”. Upon importing information such as the filmography associated with the director, correlations may be made with an upcoming features. The EPG data 152 may be searched for titles listed in the filmography. Continuing with the current example, a search of the EPG data 152 may determine that a film listed in the filmography, namely “The Abyss”, is scheduled to be shown. Specifically, the determination is made that the related feature, “The Abyss”, is scheduled to be shown on the “TNT” network at 10:30 as specified in the EPG guide 204. This information may be displayed in connection with a display of the film title “Abyss” in the filmography associated with the director James Cameron and shown in the display of information 704. As with the display of upcoming show times in FIG. 6, the display of upcoming show times in FIG. 7 may include a selectable link which, when selected by user, may cause the receiver 108 to record or set a timer to record the upcoming feature through an operation of an associated DVR or other recorder 160.

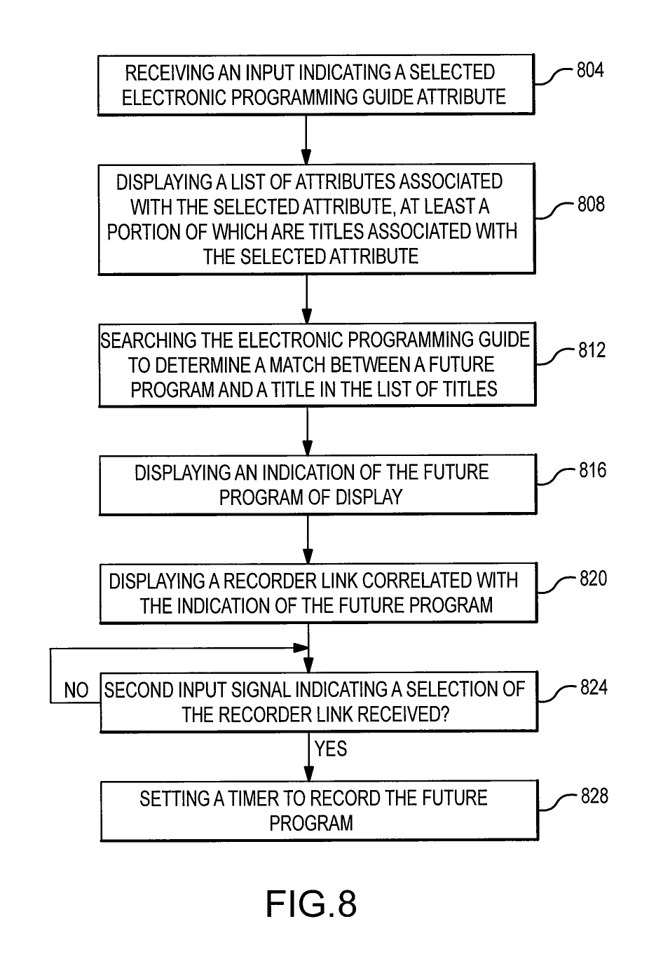

FIG. 8 is a flowchart that illustrates a method in accordance with implementations discussed herein. Initially, at operation 804, an input signal is received, indicating a selection of an selectable attribute. The signal may be received in response to a user manipulating a user input device 156 to select an EPG guide attribute 220a-n through the operation of a cursor displayed on a screen 200. After operation 804, operation 808 may be executed.

At operation 808, the display module 148 may display a list of attributes associated with the attribute selected by the user. The attributes or other information so displayed may be received in connection with a network transaction that is initiated in response to receiving the input signal. (A method for conducting such a web transaction is summarized in FIG. 5.) In operation 808, the display of the attributes may include at least some attributes which are titles. The display titles may be associated with the attribute selected by the user. For instance, as shown in FIG. 6, a user may select the actor attribute, “Kate Winslet”, and thereby be provided with a related filmography including such titles as “The Reader”, “Finding Neverland”, and so on. After operation 808, operation 812 may follow. In operation 812, the display module 148 or other module may search EPG data 152 to determine a match between one of the listed titles in a feature program that is scheduled to occur in the future. After operation 812 occurs, operation 816 may be executed.

In operation 816, the display module 148 may display an indication of the feature program that was found in operation 812 on the screen 200. Examples are shown in FIGS. 6 and 7 and include displays of indications of upcoming show times for “Finding Neverland” and “The Abyss”, respectively. After operation 816, operation 820 may be executed. In operation 820, the display module 148 may display a recorder link 628 in correlation with a display of an upcoming show time. After operation 820, operation 824 may be executed. In operation 824, a determination is made if an input signal is received indicating that a user has selected the selectable link displayed in operation 820. If an indication is received that the user has selected the link, operation 828 may follow. In operation 828, the display module 148 or other executable program running on the receiver 108 may set a timer to record the future or upcoming program which was selected by the user.

The foregoing merely illustrates certain principles of embodiments. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the embodiments and are thus within the spirit and scope of the present invention. From the above description and drawings, it will be understood by those of ordinary skill in the art that the particular embodiments shown and described are for purposes of illustration only and are not intended to limit the scope of the present invention. References to details of particular embodiments are not intended to limit the scope of the invention

1. In a receiver having at least a processor, a signal receiver and an output, a method of accessing information in an electronic programming guide, the electronic programming guide being transmitted to the receiver from a program service, the method comprising:
receiving, through a signal receiver, an input signal indicating that a selected attribute has been chosen from the electronic programming guide, the electronic programming guide being displayed on a display;
in response to receiving the input signal, selecting, by the processor, a tag associated with the selected attribute;
in response to selecting the tag, initiating a network transaction across a network to a network node, the network transaction including sending data associated with the tag through the output;
in response to initiating the network transaction, receiving a reply from the network node over the network; and
in response to receiving the reply, outputting information contained in the reply as part of a data stream for display, the information being associated with the selected attribute.

2. The method of claim 1, wherein the network node is a website and displaying information includes displaying a webpage on the display.

3. The method of claim 2, wherein the operation of displaying the webpage includes at least one of: displaying the webpage in a window on the display or displaying the webpage on the entire display.

4. The method of claim 1, further comprising selecting the network node based on a rule that defines an association between the network node and a tag header associated with the tag.

5. The method of claim 4, wherein the rule further defines an association between the tag header and a second network node.

6. The method of claim 1, wherein the operation of displaying information includes displaying a plurality of second attributes, the second attributes including information received from the network node and being associated with the selected attribute.

7. The method of claim 6, further comprising:
receiving a second input signal indicating a second selected attribute, the second selected attribute being one of the plurality of second attributes;
in response to receiving the second input signal, selecting a second tag that is associated with the second selected attribute;
in response to selecting the second tag, initiating a second network transaction across the network to a second network node, the network transaction including sending data associated with the second tag;
in response to initiating the second network transaction, receiving a reply from the second network node over the network; and
in response to receiving the reply, displaying information contained in the reply on the display, the information being associated with the second selected attribute.

8. The method of claim 6, wherein the second attributes include a list of one or more titles associated with the selected attribute, the method further comprising:
searching the electronic programming guide to determine a match between a future program and a title in the list of titles; and
displaying an indication of the future program on the display.

9. The method of claim 8, further comprising the operation of displaying a recorder link correlated with the indication of the future program.

10. The method of claim 9, further comprising:
receiving a second input signal indicating a selection of the recorder link, and
in response to receiving the second input, setting a timer to record the future program.

11. The method of claim 1, wherein the selected attribute includes at least one of a title, an actor, and actress, a director, a producer and a rating.

12. In a receiver having at least a signal receiver, a processor and network connection, a method of accessing information in an electronic programming guide, the electronic programming guide being transmitted to the receiver from a program service, the method comprising:
receiving, through a signal receiver, an input indicating that a selected attribute has been chosen from the electronic programming guide;
in response to receiving the input, receiving, through the network connection, a list of titles associated with the selected attribute from a network node;
in response to receiving the list of titles, searching, by the processor, electronic programming guide data to determine a match between a future program and a title in the list of titles; and
outputting an indication of the future program as part of a data stream for display.

13. The method of claim 12, further comprising:
displaying a recorder link correlated with the indication of the future program.

14. The method of claim 13, further comprising:
receiving a second input signal indicating a selection of the recorder link, and
in response to receiving the second input, setting a timer to record the future program.

15. A television receiving device, comprising:
a display comprising a user interface, the user interface configured to receive user input and including at least one selectable attribute;
a memory configured to store an electronic program guide data;
a network connection configured to communicate across a network with at least one network node; and
a processor in communication with the memory, the user interface and the network connection, the processor configured to display information on the display, the information being associated with the at least one selectable attribute;
wherein the information displayed on the display is received from the network node in response to a network transaction initiated by the processor;
wherein the network transaction is initiated by the processor in response to an input signal indicating a user selection of the at least one selectable attribute.

16. The television receiving device of claim 15, wherein the selected attribute is associated with a tag, the tag specifying an attribute type.

17. The television receiving device of claim 16, further comprising
a rule table stored in the memory, the rule table defining an association between at least one attribute type and at least one web destination, the network transaction being directed to the network node based on a rule in the rule table.

18. The television receiving device of claim 17, wherein the rule table may be modified to redefine an association between a particular attribute type and a particular web destination.

19. The television receiving device of claim 18, wherein the user interface includes a plurality of second selectable attributes, the second selectable attributes including information received from the network node and being associated with the selected attribute.

20. The television receiving device of claim 15, wherein the user interface includes an indication of a future program correlated with the selected attribute and a display of a recorder link correlated with the indication of the future program.
